(19) United States
(12) Patent Application Publication
(10) Pub. No.: US 2017/0144411 A1
(43) Pub. Date: May 25, 2017

(54) ALUMINUM ALLOY CLAD PLATE, AND ALUMINUM ALLOY CLAD STRUCTURAL MEMBER

(71) Applicant: Kabushiki Kaisha Kobe Seiko Sho (Kobe Steel, Ltd.), Kobe-shi (JP)

(72) Inventors: Katsushi MATSUMOTO, Kobe-shi (JP); Kazufumi SATO, Kobe-shi (JP); Hiroshi OKUDA, Kyoto-shi (JP)

(73) Assignee: Kabushiki Kaisha Kobe Seiko Sho (Kobe Steel, Ltd.), Kobe-shi (JP)

(21) Appl. No.: 15/355,550

(22) Filed: Nov. 18, 2016

(30) Foreign Application Priority Data
Nov. 20, 2015 (JP) 2015-227581

(51) Int. Cl. B32B 15/01; C22C 21/08; B32B 15/20; C22C 21/10

(52) U.S. Cl. CPC B32B 15/016; C22C 21/10; C22C 21/08; B32B 15/20

(57) ABSTRACT

Provided are an aluminum alloy clad plate for structural members, and an aluminum alloy clad structural member which have both of a high strength and formability (ductility) and further such a BH response that the plate and the member can gain a required high strength even through a high-temperature and short-period artificial aging. The clad plate is an aluminum alloy clad plate having laminated aluminum alloy layers as illustrated in FIGS. 4 and 5. The clad plate also has mutual diffusion regions in which Mg and Zn are mutually diffused between the laminated aluminum alloy layers as a phase after subjected to diffusion heat treatment, and has an inertial radius Rg and a scattering intensity I0 as shown in FIGS. 1 and 2. The factors Rg and I0 are measured by a small angle X-ray scattering technique.

### BACKGROUND OF THE INVENTION

Field of the Invention

The present invention relates to an aluminum alloy clad plate, and an aluminum alloy clad structural member obtained by forming this material into a shape, i.e., the aluminum alloy clad plate. The clad plate is a laminated plate in which aluminum alloy layers are laminated onto each other, and then joined into an integrated form by, for example, rolling.

Description of Related Art

About the body of an automobile, the airframe of an airplane, or a structural member of any other transporting machine, in which aluminum alloy plates are used as material to lighten the machine, an enhancement in the strength of the structural member tends to be incompatible with the shapability of the structural member into the shape of a product, or the ductility of the structural member.

About, for example, 7000 series aluminum alloys, or extra-super duralumin (Al-5.5% Zn-2.5% Mg alloy) for structural members, the quantity of Zn, Mg or any other element for high-strength is increased as a typical manner for heightening the strength of the structural members. However, this manner has a problem that the structural members are lowered in ductility not to be easily shaped. Moreover, when elements are made into a higher-level alloy in such a way, the alloy is lowered in corrosion resistance, or undergoes natural aging at room temperature (age-hardening) while stored, so as to be increased in strength. Thus, there is caused a problem that the alloy is remarkably lowered in shapability into a structural member, or ductility for structural members. Furthermore, there remains a problem that the efficiency of producing the alloy into plates is low because of a rolling step and other steps therefor.

Such a problem that the strength enhancement is incompatible with the shapability (ductility) is very difficult to solve only by modifying the composition or microstructure of any plate itself (simple plate or single panel) of an aluminum alloy, such as a 7000 series aluminum alloy or extra-super duralumin as described above, or modifying a producing process for the plate.

As a way toward a solution for this problem, aluminum alloy clad plates (laminated plates) have been hitherto known, which are each obtained by laminating 2 to 4 aluminum alloy layers (sheets) having different compositions or properties onto each other.

A typical example thereof is an aluminum alloy brazing sheet for heat exchangers that has a three- or four-layer structure obtained by cladding a sacrificial anode material of a 7000 series aluminum alloy, and a brazing material of a 4000 series aluminum alloy onto a core member of a 3000 series aluminum alloy.

Besides, Patent Literature 1 (JP 2004-285391 A) also suggests an aluminum alloy material for automobile fuel tanks that is composed of a core member made of a 5000 series aluminum alloy material for strength-enhancement, and a skin member made of clad members that are each a 7000 series aluminum alloy material for corrosion-improvement.

Patent Literature 2 (Japanese Patent No. 5083862) also suggests a method for producing a clad plate by laminating at most four aluminum-alloy-layers onto each other to be integrated with each other by a twin-roll-used continuous casting, using a difference in melting point between aluminum alloys such as 1000 series, 3000 series, 4000 series, 5000 series, 6000 series, and 7000 series aluminum alloys.

Furthermore, Patent Literature 3 (JP 2013-95980 A) also suggests that when plural aluminum alloy layers are laminated onto each other, corrosion-preventing Cu layers are interposed, respectively, between these aluminum alloy layers, and Cu in the corrosion-preventing Cu layers is diffused into the aluminum alloy layers joined to each other by high-temperature heat treatment, thereby improving the resultant clad plate in corrosion resistance.

However, in order to use these conventional aluminum alloy clad plates for structural members of the above-mentioned transporting machines, the clad plates need to solve the problem of the incompatibility of the strength-enhancement with the shapability (ductility) to have both of these properties.

For this reason, Patent Literature 4 suggests a raw material aluminum alloy clad plate having both of these properties for structural members of automobiles and others, or an aluminum alloy clad structural member itself obtained by subjecting this clad plate, as raw material, to a forming work such as press-forming.

An object of the technique in this Patent Literature 4 is that the clad plate or structural member can attain the compatibility of a high strength with a high press formability or ductility, which is never attainable by any single aluminum alloy plate, by laminating, as aluminum alloy plates different from each other in composition, two or more selected from Al—Mg alloy plates, Al—Zn alloy plates, and Al—Cu alloy plates onto each other.

Specifically, as illustrated in FIG. 4 or 5, the following layers are laminated onto each other in number of 3 to 7 to have a total thickness of 1 to 5 mm: Al alloy layers which each have a specific composition (including one or two of Mg in a proportion of 3 to 10% by mass and Zn in a proportion of 5 to 30% by mass) and are different from each other in composition, examples of these layers including Al—Mg alloy layers, and Al—Zn alloy layers.

This laminated plate is subjected to diffusion heat treatment to have mutual diffusion regions where Mg and Zn are mutually diffused between the laminated aluminum alloy layers, and have a microstructure in which individual joint interfacial portions between these laminated aluminum alloy layers are wholly higher in hardness than the individual laminated aluminum alloy layers, which partially constitute the joint interfacial portions.

According to the Patent Literature 4, the plate or member can attain compatibility of strength with press formability or some other property as an aluminum alloy clad plate or an aluminum alloy clad structural member for/as a structural member of automobiles and others.

However, in order to gain a high strength necessary for structural members of automobiles and others, the clad plate or structural member needs to be subjected to artificial aging at a low temperature for a long period, for example, at 120° C. for 24 hours in the same manner as single Al—Zn alloy plates (7000 series alloy plates).

In light of this point, the Patent Literature 4 naturally has no disclosure about a theme of such a BH response (bake hardenability or artificial aging hardenability) that the clad elate attains a high strength for the structural member even through artificial aging the temperature and the period for which are made high and short, respectively.

In other words, the aluminum alloy clad plate or clad structural member in the Patent Literature 4 has a problem of being unable to gain a necessary high strength by paint-bake hardening (artificial aging), the temperature and the period for which are made high and short, respectively, for example, at 160 to 205° C. for 20 to 40 minutes, this treatment being subjected to the current structural members of automobiles after the members are painted.

Unless such a problem is solved, aluminum alloy clad plates or clad structural members as disclosed in the Patent Literature 4 are not easily adopted for/as structural members of automobiles and others because of complicatedness and inefficiency following the necessity of a change in steps (conditions) for the paint-bake hardening (artificial aging).

Accordingly, aluminum alloy clad plates for aluminum alloy clad structural members are required to have not only a high strength and a high formability, but also a high BH response attained through the paint-bake hardening (artificial aging) the temperature and the period for which are made high and short, respectively.

Aluminum alloy clad structural members are also required to have not only a high strength and ductility, but also a high BH response attained through the paint-bake hardening treatment (artificial aging), the temperature and the period for which are made high and short, respectively.

### SUMMARY OF THE INVENTION

Against such problems, an object of the present invention is to provide an aluminum alloy clad plate suitable for structural members as described above, and an aluminum alloy clad structural member which each have both of a high strength and a high formability (high ductility), and further have such an excellent BH response that the clad plate or structural member can gain a required high strength even through a high-temperature and short-period artificial aging, which has been used for structural members of automobiles and others.

A subject matter of the prevent invention for attaining the object is an aluminum alloy clad plate high in strength and formability, and excellent in BH response, comprising a plurality of aluminum alloy layers;

out of the aluminum alloy layers, aluminum alloy layers inside outermost aluminum alloy layers of the aluminum alloy clad plate each comprising one or two of Mg in a proportion of 3 to 10% by mass, and Zn in a proportion of 5 to 30% by mass;

the outmost aluminum alloy layers each comprising Mg in a proportion ranging from 3 to 10% by mass, and Zn in a restrained proportion of 2% or less by mass (the proportion including 0% by mass);

any adjacent two of these aluminum alloy layers being different from each other in content by percentage of Mg or Zn therein, the total number of the aluminum alloy layers laminated onto each other being from 5 to 15, and the whole of the aluminum alloy layers having a total plate thickness of 1 to 5 mm;

about the average content by percentage of each of Mg and Zn in the aluminum alloy clad plate, the content of Mg being from 2 to 8% by mass, and the content of Zn being from 3 to 20% by mass, these contents being each a value obtained by averaging the respective Mg contents or Zn contents by percentage in the laminated aluminum alloy layers;

the aluminum alloy clad plate having a microstructure in which the average crystal grain size of respective crystals in the individual laminated aluminum alloy layers, which is obtained by averaging the respective grain sizes of the crystals, is 200 μm or less, and further in which mutual diffusion regions of Mg and Zn are present where Mg and Zn are mutually diffused between the laminated aluminum alloy layers;

about indexes each representing a distribution state in the plate-thickness direction of precipitations in the aluminum alloy clad plate,

one of these indexes being the inertial radius Rg of the precipitations which represents the size of the precipitations in each of the aluminum alloy layers and is measured by a small angle X-ray scattering technique, a central portion in the plate-thickness direction of an aluminum alloy layer in which the Mg content by percentage is the largest, out of the aluminum alloy layers, having an average inertial radius Rg ranging from 0.3 to 2.0 nm, and a central portion in the plate-thickness direction of an aluminum alloy layer in which the Zn content by percentage is the largest, out of the aluminum alloy layers, having an average inertial radius Rg ranging from 1.0 to 3M nm; and

another of the indexes being the scattering intensity I0 of the precipitations which represents the quantity of the precipitations in each of the aluminum alloy layers and is measured by the small angle X-ray scattering technique, the central portion in the plate-thickness direction of the aluminum alloy layer in which the Mg content by percentage is the largest, out of the aluminum alloy layers, having an average scattering intensity I0[Mg] ranging from 1000 to 5000, and the ratio of the average scattering intensity I0[Zn] of the central portion in the plate-thickness direction of the aluminum alloy layer in which the Zn content by percentage is the largest, out of the aluminum alloy layers, to the average scattering intensity I0[Mg] (the I0[Zn]/I0[Mg] ratio) ranging from 2.0 to 50.0.

Another subject matter of the prevent invention for attaining the object is an aluminum alloy clad structural member high in strength and ductility, and excellent in BH response, comprising a plurality of aluminum alloy layers;

out of the aluminum alloy layers, aluminum alloy layers inside outermost aluminum alloy layers of the aluminum alloy clad structural member each comprising one or two of Mg in a proportion of 3 to 10% by mass, and Zn in a proportion of 5 to 30% by mass;

the outmost aluminum alloy layers each comprising Mg in a proportion ranging from 3 to 10% by mass, and Zn in a restrained proportion of 2% or less by mass (the proportion including 0% by mass);

any adjacent two of these aluminum alloy layers being different from each other in content by percentage of Mg or Zn therein, the total number of the aluminum alloy layers laminated onto each other being from 5 to 15, and the whole of the aluminum alloy layers having a total plate thickness of 1 to 5 mm;

about the average content by percentage of each of Mg and Zn in the aluminum alloy clad structural member, the content of Mg being from 2 to 8% by mass, and the content of Zn being from 3 to 20% by mass, these contents being each a value obtained by averaging the respective Mg contents or Zn contents by percentage in the laminated aluminum alloy layers;

the aluminum alloy clad structural member having a microstructure in which the average crystal grain size of respective crystals in the individual laminated aluminum alloy layers, which is obtained by averaging the respective grain sizes of the crystals, is 200 μm or less, and further in which mutual diffusion regions of Mg and Zn are present where Mg and Zn are mutually diffused between the laminated aluminum alloy layers;

about indexes each representing a distribution state in the plate-thickness direction of precipitations in the aluminum alloy clad structural member,

one of these indexes being the inertial radius Rg of the precipitations which represents the size of the precipitations in each of the aluminum alloy layers and is measured by a small angle X-ray scattering technique, a central portion in the plate-thickness direction of an aluminum alloy layer in which the Mg content by percentage is the largest, out of the aluminum alloy layers, having an average inertial radius Rg ranging from 0.3 to 2.0 nm, and a central portion in the plate-thickness direction of an aluminum alloy layer in which the Zn content by percentage is the largest, out of the aluminum alloy layers, having an average inertial radius Rg ranging from 1.0 to 3.0 nm; and

another of the indexes being the scattering intensity I0 of the precipitations which represents the quantity of the precipitations in each of the aluminum alloy layers and is measured by the small angle X-ray scattering technique, the central portion in the plate-thickness direction of the aluminum alloy layer in which the Mg content by percentage is the largest, out of the aluminum alloy layers, having an average scattering intensity I0[Mg] ranging from 1000 to 5000, and the ratio of the average scattering intensity I0[Zn] of the central portion in the plate-thickness direction of the aluminum alloy layer in which the Zn content by percentage is the largest, out of the aluminum alloy layers, to the average scattering intensity I0[Mg] (the I0[Zn]/I0[Mg] ratio) ranging from 2.0 to 50.0.

The aluminum alloy clad plate referred to in the present invention denotes an aluminum alloy clad plate which has been obtained by laminating aluminum-alloy-clad-plate aluminum alloy layers, as material for structural members, onto each other, and then subjecting the laminate to, for example, rolling to join the alloy layers into an integrated form, and which has been subjected to a diffusion heat treatment that will be detailed later for thermal refining (hereinafter, aluminum may be referred to as Al).

The aluminum alloy clad structural member referred to in the present invention denotes a structural member which has been obtained by using the aluminum alloy clad plate subjected to the diffusion heat treatment as raw material, and forming this raw material aluminum alloy clad plate (raw material laminated plate) into a shape of a product of the structural member by, for example, press-forming, and which has not yet been subjected to artificial aging (paint-bake hardening treatment).

When the aluminum alloy clad plate which has not yet been subjected to the diffusion heat treatment is used as raw material, the aluminum alloy clad structural member referred to in the present invention denotes a structural member which has been obtained by forming this raw material aluminum alloy clad plate (raw material laminated plate) into a shape of a product of the structural member by, for example, press-forming and then subjecting the formed plate to the diffusion heat treatment, and which has not been subjected to artificial aging (paint-bake hardening).

Furthermore, about the average scattering intensity I0[Zn] and the average scattering intensity I0[Mg], [Zn] and [Mg] do not mean the average scattering intensity of Zn, and that of Mg, respectively, but mean [Zn] in an aluminum alloy layer in which the Zn content by percentage is the largest, and [Mg] in an aluminum alloy layer in which the Mg content by percentage is the largest out of the entire aluminum alloy layers. Thus, [any metal element] means [the metal element] in an aluminum alloy layer to be measured out of the alloy layers (site to be measured in these layers).

The present invention makes an aluminum alloy clad plate or an aluminum alloy clad structural member high in strength and formability (or ductility), and excellent also in BH response. Thus, a presupposition of the invention is in that the number of its layers and the thickness of its plate are each set into the above-mentioned range, and further the layers, which are aluminum alloy layers to be cladded onto each other, are each adjusted into the specific composition including Mg or Zn, in particular, a large proportion of Zn.

Under the presupposition, when the raw material described just above is at the stage of the raw material aluminum alloy clad plate, or after this clad plate is press-formed into an aluminum alloy clad structural member (made into a product shape), the raw material is subjected to diffusion heat treatment, thereby being made into an aluminum alloy clad structural member having a mutual diffusion regions of Mg and Zn where Mg and Zn are mutually diffused between the laminated aluminum alloy layers.

This diffusion of the elements causes new complex precipitations made of these elements Mg and Zn to precipitate in joint interfacial portions between these aluminum alloy layers.

In addition to the above, in the present invention, after the diffusion heat treatment, the microstructure of the aluminum alloy clad plate or the aluminum alloy clad structural member is further controlled and specified in order for the plate or the structural member to ensure a high strength (BH response), which is required for structural members of transporting machines, even through artificial aging the period for which is made short.

Specifically, when the new complex precipitations made of, e.g., Mg and Zn are precipitated in the joint interfacial portions between the aluminum alloy layers, each of the aluminum alloy layers cladded under the diffusion heat treatment conditions is controlled into a specific range about each of the size and the quantity of the precipitations that are measured by a small angle X-ray scattering technique.

This control makes it possible that the diffusion-heat-treated alloy layers have such a BH response (referred to also as bake hardenability, paint-bake hardenability or artificial aging hardenability) that the resultant clad plate or structural member can gain a required high strength even through a high-temperature and short-period artificial aging, which is used for structural members of automobiles and others.

According to this matter, the present invention makes it possible that a raw material aluminum alloy clad plate subjected to a diffusion heat treatment has both of a high strength and a high formability, and further that the clad plate, as well as an aluminum alloy clad structural member obtained by forming the clad plate into a shape, is made excellent in BH response to gain a required high strength even through a high-temperature and short-period artificial aging used for structural members of automobiles.

### BRIEF DESCRIPTION OF THE DRAWINGS

FIG. 1 is a graph showing a distribution (change) of the inertial radius Rg of precipitations in an aluminum alloy clad plate of the present invention in the plate-thickness direction thereof.

FIG. 2 is a graph showing a distribution (change) of the scattering intensity I0 of the precipitations in the aluminum alloy clad plate of the invention in the plate-thickness direction.

FIG. 3 is a view showing X-ray scattering intensities in the plate in the plate-thickness direction, which are bases of the data in FIGS. 1 and 2.

FIG. 4 is a sectional view illustrating an embodiment of the aluminum alloy clad plate of the invention.

FIG. 5 is a sectional view illustrating another embodiment of the aluminum alloy clad plate of the invention.

FIG. 6 is a graph showing mutual diffusion regions of Mg and Zn in an aluminum alloy clad plate of the invention.

### DESCRIPTION OF PREFERRED EMBODIMENTS OF THE INVENTION

Initially, a description is made about a structure as the presupposition of a raw material aluminum alloy clad plate suitable for structural members as described above, and an aluminum alloy clad structural member (hereinafter also referred to merely as a clad structural member). In any description of embodiments given below, the meaning of a prescription of the composition, the laminating manner or some other factor of aluminum alloy layers in each of a raw material aluminum alloy clad plate and an aluminum alloy clad structural member may be read as the meaning of a prescription of the same factor of aluminum alloy plates or aluminum alloy ingots before the cladding.

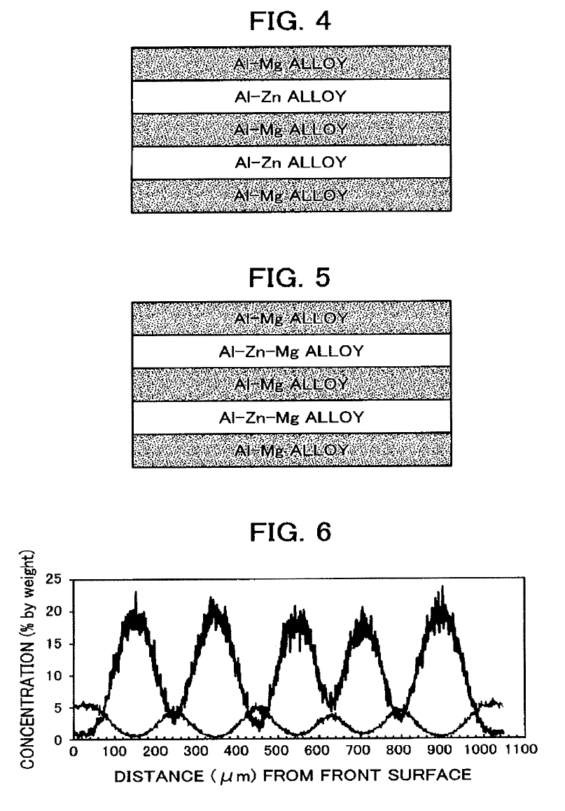

FIGS. 4 and 5 each illustrate a partial cross section of a flat-plate portion in the width direction or rolling direction (longitudinal direction) of a raw material aluminum alloy clad plate (hereinafter also referred to merely as a clad plate, a raw material plate, or a raw material clad plate), or an aluminum alloy clad structural member obtained after this plate is press-formed (hereinafter also referred to merely as a clad structural member).

In the aluminum alloy clad structural member, such a sectional structure extends over the whole of the production shape of the member, and in the raw material plate, the structure extends evenly (uniformly) over the whole in the width direction or rolling direction of the plate.

### Laminating Manner:

In the raw material clad plate (clad structural member) of the present invention, aluminum alloy layers each including one or more of Mg and Zn in one or two specified content ranges are laminated (cladded) onto each other in number of 5 to 15 to make any adjacent two of these aluminum alloy layers different from each other in content by percentage of Mg or Zn therein. The whole of the layer-laminated aluminum alloy plate has a total plate thickness of 1 to 5 mm. Thus, the raw material clad plate (clad structural member) is a relatively thin clad structural member (raw material clad plate).

In the raw material clad plate (clad structural member) of the present invention, it is necessary to change the manner of laminating the aluminum alloy layers combined with each other when these layers are laminated onto each other in accordance with the individual components of the layers. With reference to FIGS. 4 and 5, this laminating manner will be described hereinafter.

FIG. 4 illustrates an example in which: Al—Mg alloy layers (aluminum alloy layers A in Table 1, which will be later described), are rendered outermost aluminum alloy layers (both outermost layers, or two outermost layers); an Al—Zn alloy layer (aluminum alloy layer B in Table 1) is laminated onto the inside (inward surface or inner surface) of each of the outermost layers; as the center of the laminate, an Al—Mg alloy layer (aluminum alloy layer A in Table 1) is located; and thus these layers are laminated onto each other in number of 5 totally.

FIG. 5 illustrates an example in which: as well, Al—Mg alloy layers (aluminum alloy layers A in Table 1, which will be later described), are rendered outermost aluminum alloy layers (both outermost layers, or two outermost layers); an Al—Zn—Mg alloy layer is laminated onto the inside of each of the outermost layers; as the center of the laminate, an Al—Mg alloy layer (an aluminum alloy layer A in Table 1) is located; and thus these layers are laminated onto each other in number of 5 totally.

The example in each of FIGS. 4 and 5 is an example in which plates (or layers) laminated onto each other are rendered aluminum alloy layers which each include one or more of Mg and Zn in one specified or respective specified content ranges, and which are different from each other in content by percentage of at least Mg or Zn therein.

Out of the combined aluminum alloy layers, the Al—Zn alloy layers in FIG. 4 or the Al—Zn—Mg alloy layers in FIG. 5, which each contain Zn in the specified content range by percentage, are poor in corrosion resistance. Thus, in order to ensure the corrosion resistance of the clad plate, these alloy layers are laminated to be inside the clad.

When these Zn-containing aluminum alloy layers are laminated to be at the respective outsides (surface sides or surface layer sides) of the clad, the clad structural member is lowered in corrosion resistance since the Zn content by percentage therein is large.

Accordingly, in FIGS. 4 and 5, Al—Mg alloy or any other aluminum alloy layers each containing Mg in a proportion of 3 to 10% by mass are laminated, respectively, onto the outmost (both-outermost side, both-surface side, or both-surface-layer side) aluminum alloy layers of the clad.

However, also in such an Al—Mg alloy or any other alloy, the clad plate or structural member is also lowered in corrosion resistance when the alloy contains Zn or Cu in a large proportion besides Mg.

It is therefore necessary to use aluminum alloy layers in each of which the Zn content by percentage is restrained into a proportion of 2% or less by mass (including 0% by mass) not to lower the corrosion resistance largely.

It is more effective to make the number of the laminated layers (the number of ingots or plates, which will be detailed later) larger in order for the raw material clad plate (clad structural member) to exhibit properties thereof more greatly. The number needs to be 5 or more. If the number is 4 or less, the resultant relatively thin aluminum alloy clad plate, which has a plate thickness of 1 to 5 mm, is not largely different in properties from any simple aluminum alloy plate (single aluminum alloy plate). Thus, the laminating is insignificant. If the number of the laminated layers is more than 15, the properties of the clad plate are expectable to be further improved. However, a process therefor is inefficient and unrealistic, considering the producing performance of any practical production process. Thus, the upper limit of the number is 15.

### Method for Producing Raw Material Clad Plate:

A description will be made about a method for producing the raw material clad plate in the present invention.

When an ordinary simple plate (single plate) is made into a high alloy as seen in the present invention, for example, when a 7000 series alloy is prepared to contain Mg in a proportion up to 10% by mass or Zn in a proportion up to 30% by mass, the plate is extremely lowered in ductility to undergo, e.g., rolling cracking, so that the plate cannot be rolled.

In contrast, the present invention makes use of laminated plates (laminated ingots) which are composed of thin plates different from each other in composition; thus, even when the thin plates are made into high alloys as described above, the thin plates are high in ductility. Consequently, the thin plates can be hot-rolled, as well as cold-rolled, into a thin clad plate. In other words, the clad plate of the present invention before subjected to diffusion heat treatment has an advantage that the clad plate can be produced as a rolled clad plate through an ordinary rolling step.

For this reason, 5 to 15 aluminum alloy ingots or plates which each contain one or two of Mg and Zn in the (respective) specified content range(s) and which are different from each other in content by percentage of Mg or Zn therein are laminated (cladded) onto each other before rolled into a clad plate. In the same way as in an ordinary rolling step, the laminate is subjected to homogenization, as needed. Thereafter, the resultant can be hot-rolled into a clad plate.

In order to make the clad plate thinner within the plate thickness range, the clad plate is cold-rolled while subjected to process annealing as needed. This rolled clad plate is subjected to thermal refining (heat treatment such as annealing or solutionizing) as needed to produce a clad plate of the present invention.

It is allowable to subject the aluminum alloy ingots to homogenization separately from each other, put and laminate the plates onto each other after the homogenization, re-heat the laminated ingots to a temperature for hot-rolling, and then hot-roll the laminated plates, or to subject the aluminum alloy ingots to homogenization separately from each other, hot-roll the plates thereafter separately from each other, subject the plates separately from each other to process annealing or cold rolling into a plate thickness suitable for each of the plates, put and laminate the plates thereafter onto each other into a plate material, and further cold-roll the plate material into a clad plate.

The reason why the plate thickness of the whole of the clad plate of the present invention is set into a relatively small range of 1 to 5 mm is that any plate thickness in this range is a plate thickness used widely for structural members of transporting machines as described above. If the plate thickness is less than 1 mm, the clad plate does not satisfy a property necessary for the structural members, such as rigidity, strength, workability, or weldability. In the meantime, if the plate thickness is more than 5 mm, the clad plate is not easily press-formed into structural members of the transporting members. Moreover, the clad plate cannot attain lightness necessary for structural members of the transporting members by an increase in the weight.

In order to set the plate thickness of the whole of the finally obtained clad plate into the range of 1 to 5 mm by the rolling clad method, the thickness (plate thickness) of each of the ingots ranges from about 50 to 200 mm although the thickness depends, of course, on the number (layer number) of the ingots to be laminated, the roll ratio and other factors. When the plate thickness of the whole of the finally obtained clad plate ranges from 1 to 5 mm, the thickness of each of the laminated alloy layers is from about 0.05 to 2.0 mm (50 to 2000 μm) although the thickness depends on the number (layer number) of the layers to be laminated.

In the case of the process of subjecting aluminum alloy ingots separately from each other to homogenization, and hot rolling or cold rolling, laminating the rolled ingots thereafter, and then cold-rolling the laminated ingots into a clad plate, the thickness of each of the plates at the laminating stage is from about 0.5 to 5.0 mm although the thickness depends, of course, on the number (layer number) of the ingots to be laminated, the roll ratio and other factors.

### Diffusion Heat Treatment:

After the cold rolling into the predetermined plate thickness, the plate is subjected to diffusion heat treatment as thermal refining (heat treatment). This diffusion heat treatment may be performed after the cold rolling, or may be performed, as an operation in a series of heat treatments after the cold rolling, after solutionizing or quenching treatment of the plate. The diffusion heat treatment may be performed in a process annealing in the middle of the heat treatment after the clad rolling or in the middle of the cold rolling into the predetermined plate thickness.

A step may be adopted in which after the diffusion heat treatment is performed at any stage, the resultant is subjected to solutionizing treatment before subjected to a forming test. In this case, the average cooling rate after the solutionizing treatment may be set to 35° C./second or more in a temperature range from a temperature for the solutionizing treatment to 100° C., and set to 30° C./second or less in a temperature range from 100° C. to room temperature. In this way, the same advantageous effects as produced in the case of performing only the diffusion heat treatment are produced without hindering advantageous effect of the diffusion heat treatment, which will be detailed later.

The clad plate may be subjected to diffusion heat treatment at a stage when subjected to artificial aging (paint-bake treatment) after formed into a structural member.

Conditions for this diffusion heat treatment are very important for causing the clad plate to have mutual diffusion regions of Mg and Zn where Mg and Zn are mutually diffused between the laminated aluminum alloy layers, and for precipitating new complex precipitations (aging precipitations) made of, e.g., these elements Mg and Zn and formed by the diffusion of the elements at joint interfacial portions between these aluminum alloy layers.

Specifically, by this diffusion heat treatment, each of the cladded aluminum alloy layers is controlled into a specific range about each of the size and the quantity of the precipitations that are measured by a small angle X-ray scattering technique. This control makes it possible to cause the raw material aluminum alloy clad plate to have both of a high strength and a high formability, and further make this clad plate, as well as an aluminum alloy clad structural member formed from this clad plate, excellent in BH response, so that the plate or member can gain a required high strength even through artificial aging that has been used for structural members of automobiles and others.

Thus, the diffusion heat treatment conditions are conditions that this treatment is conducted in a heating temperature range from 460 to 550° C. both inclusive for a holding period from 10 minutes to 100 hours both inclusive.

As the treatment temperature is higher and the holding period is longer, the diffusion is further advanced to make the strength-increasing effect greater. If the temperature is lower than 460° C. or the holding period is less than 10 minutes, the diffusion heat treatment becomes insufficient so that the size or the quantity of the precipitations, which is measured by the small angle X-ray scattering technique, may not satisfy the lower limit specified therefor.

If the heating temperature is higher than 550° C. or the holding period is longer than 100 hours, Zn is remarkably diffused to the surface layer sides of the clad plate by the advance of the diffusion so that the size or the quantity of the precipitations, which is measured by the small angle X-ray scattering technique, exceeds the upper limit therefor to hinder the ductility-improving effect based on solid-solutionized Mg. Moreover, the average crystal grain size obtained by averaging the respective crystal grain sizes of the laminated aluminum alloy layers may become more than 200 μm.

Furthermore, immediately after the diffusion heat treatment under the above-mentioned conditions, without delay the clad plate is rapidly cooled. This cooling is performed preferably at two stages described below in accordance with temperature ranges of the plate.

Specifically, initially, in the first stage cooling, the clad plate is rapidly cooled at an average cooling rate of 35° C./second or more in a high-temperature range from a temperature for the diffusion heat treatment to 100° C. A manner or means itself for this rapid cooling may be a water cooling manner, an air cooling manner, or any other known cooling manner or means.

Furthermore, in the second stage cooling subsequent to the first stage cooling, the clad plate is cooled at a relatively small average cooling rate of 30° C./second or less in a temperature range from 100° C. to room temperature.

It is preferred that the clad plate is cooled at the two-level average cooling rate in this way, that is, that the temperature range from the diffusion heat treatment temperature to room temperature is divided into two parts at a boundary of 100° C., and the clad plate is rapidly cooled in the high-temperature side of this temperature range and slowly cooled in the low-temperature side thereof.

In this way, in the individual aluminum alloy layers, and the mutual diffusion regions, atomic holes are frozen which promote the generation of an oversaturated solid solution state necessary for the production of aging precipitations at the artificial aging (paint-bake hardening) time, and which further promote aging precipitation. Furthermore, by controlling the temperature range from 100° C. to room temperature into the above-mentioned average cooling rate, an aging-precipitation-form for giving desired properties to the clad plate of the present invention can be gained. The control of this cooling process makes it possible that the clad plate gains a desired BH response.

If the first stage cooling rate is less than 35° C./second, or the second stage cooling rate is more than 30° C./second, the size or quantity of the precipitations, which is measured by the small angle X-ray scattering technique, may not satisfy the lower limit specified therefor.

The clad plate can gain more preferred properties by setting the cooling rate more preferably to 60° C./second or more, even more preferably to 100° C./second or more in the first stage temperature range, in which the temperature of the plate turns from the diffusion heat treatment temperature to 100° C., and setting the cooling rate more preferably to 20° C./second or less, even more preferably to 15° C./second or less in the second stage temperature range, in which the temperature of the plate turns from 100° C. to room temperature.

Naturally, however, the mutual diffusion of Mg and Zn between the aluminum alloy layers by the diffusion heat treatment, and the average crystal grain size after the diffusion heat treatment are largely varied by the respective compositions of the laminated aluminum alloy layers, the number of the laminated layers, and the combination of the laminated layers.

Accordingly, in accordance with the above-mentioned conditions for the aluminum alloy layers to be laminated, the temperature is too low or the holding period is too short even when the conditions are within the above-mentioned condition range. Consequently, the mutual diffusion of Mg and Zn between the aluminum alloy layers becomes insufficient. Thus, the precipitations may not come to have the size or the quantity specified by the small angle X-ray scattering technique.

It is therefore necessary to gain (select) optimal conditions for the temperature and the period for the diffusion heat treatment, as will be performed in the item “Examples” described later, in accordance with the composition of the aluminum alloy layers to be laminated, the number of the laminated layers, and the combination of the laminated layers, and make controls delicately.

About this point, according to the Patent Literature 4, diffusion heat treatment was performed at 450° C. for 1 hour as described in the item “Examples” thereof. Thus, the diffusion heat treatment temperature is low, and the average cooling rate from the diffusion heat treatment temperature to room temperature is unclear. Accordingly, an aluminum alloy clad plate or an aluminum alloy clad structural member cannot be formed into a microstructure (the size or quantity of precipitation regions thereof) specified by a small angle X-ray scattering technique, so that the plate or member may not ensure a BH response obtained when subjected to the short-period artificial aging as described above.

### Aluminum Alloy:

Hereinafter, a description will be made about the composition of the aluminum alloy layers in the clad (the structural member, or the raw material plate before formed into the structural member) before the diffusion heat treatment.

As described above, the outermost (both-side outermost) aluminum alloy layers are each rendered an aluminum alloy layer in which Mg is contained in a proportion of 3 to 10% by mass and the Zn content is restrained into 2% or less by mass (including 0% by mass) not to lower the corrosion resistance largely.

In the meantime, the composition of each of the plural aluminum alloy layers or 3 to 13 laminated aluminum alloy layers inside the outermost aluminum alloy layers is set to contain one or two of Mg in a proportion of 3 to 10% by mass, and Zn in a proportion of 5 to 30% by mass. In other words, the composition of the aluminum alloy plates or ingots before cladded (laminated) onto each other, or the cladded aluminum alloy layers is set to contain one or two of Mg in a proportion of 3 to 10% by mass, and Zn in a proportion of 5 to 30% by mass.

When the composition of each of the aluminum alloy layers inside the outermost aluminum alloy layers contains two of Mg in a proportion of 3 to 10% by mass and Zn in a proportion of 5 to 30%© by mass (ternary type composition), it is preferred to make Zn larger in content by percentage than Mg in order to improve or ensure the strength of the whole of the clad.

About the average content of each of Mg and Zn by percentage in the whole of the aluminum alloy clad plate which is the clad (the structural member, or the raw material plate before formed into the structural member) before the diffusion heat treatment, the content of Mg in the laminated aluminum alloy layers is set to a range of 2 to 8% by mass, and the content of Zn therein, to a range of 3 to 20% by mass. These contents are each a value obtained by averaging the respective Mg or Zn contents by percentage in the laminated aluminum alloy layers.

In order for the clad plate of the present invention to have both of formability and strength, it is necessary that the aluminum alloy layers which each have the above-mentioned composition and are different from each other in content by percentage of at least Mg or Zn are laminated onto each other, and the aluminum alloy clad plate contains, as a whole thereof, each of Mg and Zn in the above-mentioned content range.

### Composition of Aluminum Alloy Layers:

These aluminum alloy layers, which contain one or two of Mg in a proportion of 3 to 10% by mass and Zn in a proportion of 5 to 30% by mass, may be made of an Al—Zn or Al—Mg binary aluminum alloy. The layers may be, for example, made of an Al—Zn—Mg, Al—Zn—Cu, Al—Mg—Cu or some other ternary alloy, an Al—Zn—Cu—Zr or some other quaternary alloy, or an Al—Zn—Mg—Cu—Zr or some other quinary alloy, in each of which Zn, Mg and/or an optional element such as Cu, Zr or Ag is/are added to the binary aluminum alloy.

These aluminum alloy layers are combined/laminated with/onto each other to join any adjacent two of these layers onto each other to be different from each other in Mg or Zn content by percentage. As a whole of the clad plate, the aluminum alloy layers are laminated onto each other in a predetermined number in such a manner that the whole of the clad plate contains Mg and Zn, or one or more optional additive elements such as Cu, Zr and/or Ag in the above-mentioned respective average content ranges.

Hereinafter, a description will be made about the significance of the incorporation or the incorporation-control of each of the elements for the composition of the aluminum alloy layers to be cladded or the clad plate. In the case of the composition for the clad plate, the content by percentage of each of the elements is read in the state of being changed from the content by percentage of the element in the aluminum alloy layers to the average of the respective contents of the element by percentage in the laminated individual plates (entire plates). The symbol “%” about any content by percentage that will be described hereinafter denotes % by mass.

### Mg: 3 to 10%

Mg, which is an essential alloying element in the outermost aluminum alloy layers and the aluminum alloy layers laminated inside these outermost layers, forms clusters (fine precipitations), together with Zn, in the microstructure of the clad plate or the clad structural member to improve the work hardenability (formability or ductility) thereof. Moreover, Mg forms aging precipitations in the microstructure or joint interfacial portions of the clad plate or the clad structural member to improve the strength thereof. If the Mg content is less than 3%, the strength is insufficient. If the content is more than 10%, casting cracks are generated, and further the cladded plates (ingots) are lowered in ductility not to be easily produced.

### Zn: 5 to 30%

Zn, which is an essential alloying element in the aluminum alloy layers laminated inside the outermost layers, forms clusters (fine precipitations), together with Mg, in the microstructure of the clad plate or the clad structural member to improve the work hardenability (formability or ductility) thereof. Moreover, Zn forms aging precipitations in the microstructure or joint interfacial portions of the clad plate or the clad structural member to improve the strength thereof. If the Zn content is less than 5%, the strength is insufficient and balance between the strength and the formability is also lowered. If the content is more than 30%, casting cracks are generated, and further the cladded plates (ingots) are lowered in ductility, so that a clad plate is not easily produced. Even when the clad plate can be produced, grain boundary precipitations MgZn₂ increase in quantity to cause grain boundary corrosion easily. Thus, the clad plate is remarkably deteriorated in corrosion resistance, and is also lowered in formability.

### One or More of Cu, Zr and Ag

Cu, Zr and Ag in the outermost aluminum alloy layers and the aluminum alloy layers laminated inside these outermost layers are equivalent-effect elements for improving the clad plate or the clad structural member in strength although these elements are somewhat different in effect mechanism from each other. These elements are incorporated into the alloy as needed.

Cu has an effect of improving the corrosion resistance even in a small quantity besides the strength improving effect. Zr makes the crystal grains finer in the ingots and cladded plates, and Ag makes aging precipitations finer which are produced in the microstructure or joint interfaces of the clad plate or the clad structural member to each have the strength improving effect even in a small quantity.

However, if the content by percentage of any one of these elements Cu, Zr and Ag is too large, the clad plate is not easily produced. Even when the clad plate can be produced, the plate is conversely lowered in corrosion resistance such as SCC resistance, or conversely lowered in ductility or strength properties. In such a way, various problems are caused. Accordingly, when these are optionally incorporated into the alloy, the contents of Cu, Zr and Ag are set into respective ranges of 0.5 to 5%, 0.3% or less (not including 0%), and 0.8% or less (not including 0%).

### Other Elements:

Elements other than the above-mentioned elements are inevitable impurities in the outermost aluminum alloy layers and the aluminum alloy layers laminated inside these outermost layers. The incorporation of these impurities is supposed (accepted) which is based on the use of aluminum alloy scrap, besides pure aluminum virgin metal, as melting raw material. Thus, the incorporation is allowable. Specifically, unless elements described below are each in a content range described below, the incorporation of the elements is allowable since the ductility and strength properties of the clad plate according to the present invention are not lowered. Fe: 0.5% or less; Si: 0.5% or less; Li: 0.1% or less; Mn: 0.5% or less; Cr: 0.3% or less; Sn: 0.1% or less; and Ti: 0.1% or less.

### Composition of Whole of Clad Plate:

In the present invention, the average content by percentage of each of Mg and Zn is specified through the average composition of the whole of the clad plate before the diffusion heat treatment, as well as through the composition of the aluminum alloy layers.

The average content by percentage of each of Mg and Zn in the whole of the clad plate is calculated as a weighted arithmetical average value obtained through an operation of giving a weighting factor to the Mg or Zn content by percentage in each of the laminated aluminum alloy layers, corresponding to the above-mentioned clad ratio. The respective average contents by percentage of Mg and Zn in the whole of the clad plate are as follows as the weighted arithmetical average values: Mg: 2 to 8%; and Zn: 3 to 20%.

In other words, the average composition of the whole of the clad plate is rendered a composition containing one or two of Mg and Zn in the (respective) average content range range(s), and further containing one or more of Cu, Zr and Ag optionally, the balance of the composition being made of aluminum and inevitable impurities.

The average content by percentage of each of Mg and Zn in the whole of the clad plate is rendered a weighted arithmetical average value obtained through an operation of giving a weighting factor to the Mg or Zn content by percentage in the aluminum alloy constituting each of the laminated aluminum alloy layers of the clad plate, corresponding to the clad ratio of the aluminum alloy layer. For example, when individual aluminum alloy layers in a five-layered aluminum alloy clad plate have thicknesses equal to each other, the clad ratio of each of the aluminum alloy layers is 20%. The clad ratio is used to calculate out the weighted arithmetical average value of each of Mg and Zn, and this value is defined as the average content by percentage of Mg or Zn in the whole of the clad plate.

If about this average composition of the whole of the clad plate the Mg or Zn content by percentage is less than the above-mentioned lower value since the average Mg or Zn content by percentage is too small, Mg and Zn, or others are insufficiently diffused into the microstructure of the laminated plates as a microstructure obtained after the clad plate is subjected to diffusion heat treatment at 500° C. for 2 hours.

As a result, this diffusion makes the precipitation quantity insufficient which is a quantity of new complex precipitations (aging precipitations) made of these elements Mg, Zn, and/or other elements onto joint interfacial portions between the layers. Accordingly, the total thickness of mutual diffusion regions of Mg and Zn in the plate-thickness direction becomes too small, so that the aluminum alloy clad plate cannot be heightened in strength. Specifically, about the strength of the aluminum alloy clad structural member obtained after the artificial aging, the member cannot have a 0.2%-yield-strength of 400 MPa or more.

In the meantime, if about the average composition of the whole of the clad plate the Mg or Zn content by percentage is more than the above-mentioned upper value since the average Mg or Zn content by percentage is too large, the clad plate is remarkably lowered in ductility. Accordingly, the clad plate is lowered down in press formability to a level equivalent to that of 7000 series aluminum alloy plates, extra-super duralumin plates, 2000 series aluminum alloy plates, and 8000 series aluminum alloy plates for structural members. Thus, it is insignificant to make the raw material alloy into the clad plate.

The present invention aims to be an alternate product for 7000 series aluminum alloy, extra-super duralumin (Al-5.5% Zn-2.5% Mg alloy), and 2000 series and 8000 series aluminum alloy plates. Specifically, the invention has the following matter as a principal objective: at the stage of the clad plate as a forming raw material, this highly strong material is largely improved in ductility; and after this material is formed into a structural member, the structural member is made as high in strength as a high-strength material made of such a conventional single plate by diffusion heat treatment or artificial aging. It is therefore necessary to make the composition of the finally obtained clad plate, as the composition of the whole of the cladded plates, equal to or close to that of 7000 series aluminum alloy plates, extra-super duralumin plates, and 2000 series and 8000 series aluminum alloy plates for structural members.

From such a viewpoint, therefore, it is significant to make the composition of the clad plate of the present invention close to that of a single plate of a conventional 7000 series, extra-super duralumin, a 2000 series or 8000 series aluminum alloy plate, or any other conventional aluminum alloy plate for structural members. Specifically, it is significant that the clad plate of the invention contains one or two of Mg in a proportion of 3 to 10%, and Zn in a proportion of 5 to 30%, Mg and Zn being main elements of such conventional aluminum alloy plates.

In light of this point, the clad plate of the present invention, or aluminum alloy layers therein may contain Si and Li, which are optionally contained in the above-mentioned conventional aluminum alloy plates.

### Microstructure of Clad Structural Member:

In the present invention, under conditions that the above-mentioned alloy composition itself or alloy composition combination is used as described above, in the present invention, the aluminum alloy clad plate or an aluminum alloy clad structural member obtained by forming this plate into a shape is specified about the microstructure thereof after subjected to diffusion heat treatment and before artificial aging (T6 treatment).

By the diffusion heat treatment, Mg and Zn contained in the cladded aluminum alloy layers are mutually diffused between the laminated (joined) aluminum alloy layers.

By the mutual diffusion of the elements, new Zn—Mg based fine complex precipitations (aging precipitations), which are made of these elements Mg and Zn or other elements, are precipitated into a high density at joint interfacial portions between the layers to make an interfacial portion phase control (super-high-density distribution of nano-level size fine precipitations).

The microstructure that is a presupposition of the aluminum alloy clad structural member is rendered a microstructure in which the crystal grain size of each of the laminated aluminum alloy layers is set to 200 μm or less, and is further rendered a microstructure having mutual diffusion regions of Mg and Zn in which Mg and Zn are mutually diffused between the laminated aluminum alloy layers.

### Mutual Diffusion Phase:

The mutual diffusion phase referred to in the present invention is a phase of the aluminum alloy clad plate or aluminum alloy clad structural member that is obtained after the average crystal grain size of the aluminum alloy layers is specified and further the plate or member is subjected to the diffusion heat treatment. The phase can be identified and estimated, without observing the structural member obtained by forming the raw material aluminum alloy clad plate into a shape, at the stage of the raw material aluminum alloy clad plate.

A presupposition for diffusing Mg and Zn contained in the aluminum alloy layers mutually between the laminated aluminum alloy layers is that the laminated aluminum alloy layers are aluminum alloy layers which each contain one or two of Mg and Zn in the (respective) specified content range(s), and which are different from each other in at least Mg or Zn content by percentage.

In other words, even when the layers equal to each other in contents by percentage of Mg and Zn are different from each other in content by percentage of any other element, Mg and Zn are not mutually diffused between any two joined layers out of the entire layers, so that new fine complex precipitations (aging precipitations) of Mg and Zn cannot be precipitated with a high density at the joint interfacial portions between the layers.

Accordingly, the matter that the cladded aluminum alloy layers are each made into the specified composition containing Mg and Zn in respective large proportions, and any two layers laminated and joined onto each other, out of the layers, are rendered layers different from each other in at least Mg or Zn content by percentage is a composition or structure not only for mere ductility but also for precipitating complex precipitations, at the joint interfacial portions between the layers, through the diffusion of the elements by the diffusion heat treatment.

### Average Crystal Grain Size:

In order to ensure the expression of a high-strength-attaining mechanism by the matter that the present invention has the mutual diffusion regions of Mg and Zn, where Mg and Zn are mutually diffused between the laminated aluminum alloy layers, the microstructure of the aluminum alloy clad plate or aluminum alloy clad structural member after the diffusion heat treatment and before the artificial aging (T6 treatment) is rendered a microstructure in which the average crystal grain size of each of the laminated aluminum alloy layers (plate-thickness-central portions) is 200 μm or less.

This matter means that even by the diffusion heat treatment and the subsequent artificial aging (T6 treatment), the following is not caused: the crystal grains are made coarse so that the average crystal grain size obtained by averaging the respective crystal grain sizes of the laminated aluminum alloy layers (plate-thickness-central portions) is more than 200 μm.

If the average crystal grain size obtained by averaging all of the respective crystal grain sizes of the laminated aluminum alloy layers (plate-thickness-central portions) is more than 200 μm, many crystal grains in the laminated aluminum alloy layers become coarse to have a crystal grain size more than 200 μm.

Thus, a possibility may be generated that the aluminum alloy clad structural member obtained after subjected to the T6 treatment and further paint-bake treatment cannot have a 0.2%-yield-strength of 400 MPa or more.

When the aluminum alloy layers combined with each other for the thickness of the clad plate of the present invention and the laminating of the layers are each large in thickness, a contribution of the average crystal grain size per aluminum alloy layer is small to the strength and formability. In the present invention, however, the aluminum alloy layers are laminated (cladded) in a number of 5 to 15, and further the plate thickness of the whole of these cladded plates laminated is as small as a value of 1 to 5 mm; thus, a contribution of the average crystal grain size per aluminum alloy layer is remarkably increased to the strength and formability.

### Distribution State of Precipitations in Plate-Thickness Direction:

The present invention is further characterized by specifying the distribution state in the plate-thickness direction of the precipitations in the aluminum alloy clad plate or aluminum alloy clad structural member after the diffusion heat treatment and before the artificial aging (T6 treatment) to improve the BH response in such a manner that the plate or member can gain a required high strength even through the artificial aging which is high-temperature and short-period artificial aging for structural members of automobiles.

Specifically, the following two, as indexes representing the distribution state in the plate-thickness direction of the precipitations in the aluminum alloy clad plate or aluminum alloy clad structural member after the diffusion heat treatment, are controlled by selecting conditions for the diffusion heat treatment: the inertial radius Rg representing the size of the precipitations in specified one of the aluminum alloy layers, and the scattering intensity I0 representing the quantity of the precipitations in each of the aluminum alloy layers, these factors being measured by a small angle X-ray scattering technique.

In this way, the present invention can gain such a BH response that the invention has a high formability at a raw material plate stage thereof, and can gain a required high strength through the high-temperature and short-period artificial aging.

Specifically, initially, as one of the indexes representing the distribution state in the plate-thickness direction of the precipitations in the raw material plate or clad structural member after the diffusion heat treatment, the inertial radius Rg representing the size of precipitations in each of the aluminum alloy layers is specified, this radius being measured by a small angle X-ray scattering technique.

Precisely, a central portion in the plate-thickness direction of an aluminum alloy layer in which the Mg content by percentage is the largest (larger than the Zn content by percentage), out of the aluminum alloy layers, has an average inertial radius Rg ranging from 0.3 to 2.0 nm.

Simultaneously, a central portion in the plate-thickness direction of an aluminum alloy layer in which the Zn content by percentage is the largest (larger than the Mg content by percentage), out of the aluminum alloy layers, has an average inertial radius Rg ranging from 1.0 to 3.0 nm.

If the former average inertial radius Rg is less than 0.3 mm or the latter average inertial radius Rg is less than 1.0 nm, the size of the precipitations is too small so that the precipitations do not contribute to the BH response.

In the meantime, if the former average inertial radius Rg is more than 2.0 mm or the latter average inertial radius Rg is more than 3.0 nm, the clad plate is extremely increased in strength after the diffusion heat treatment to be lowered in ductility. Furthermore, the aging precipitation generated at the diffusion heat treatment time has been already promoted; thus, the precipitations do not contribute to the BH response after the time.

Simultaneously, about the scattering intensity JO representing the quantity of the precipitations in each of the aluminum alloy layers and measured by the small angle X-ray scattering technique, the central portion in the plate-thickness direction of the aluminum alloy layer in which the Mg content by percentage is the largest, out of the aluminum alloy layers, has an average scattering intensity I0[Mg] ranging from 1000 to 5000.

Simultaneously, the ratio of the average scattering intensity I0[Zn] of the central portion in the plate-thickness direction of the aluminum alloy layer in which the Zn content by percentage is the largest, out of the aluminum alloy layers, to the average scattering intensity I0[Mg] of the central portion (the I0[Zn]/I0[Mg] ratio) ranges from 2.0 to 50.0.

As described above, the average scattering intensity I0[Zn] and the average scattering intensity I0[Mg] do not mean the average scattering intensity of Zn, and that of Mg, respectively, but mean the average scattering intensity I0 of Zn in the aluminum alloy layer in which the Zn content by percentage is the largest, and that I0 of Mg in the aluminum alloy layer in which the Mg content by percentage is the largest, i.e., that I0 of Mg and that I0 of Zn in respective sites to be measured (respective positions to be measured) in the alloy layers.

If the average scattering intensity I0[Mg] is less than 1000 or the ratio of the average scattering intensity I0[Zn] to the average scattering intensity [Mg] ratio (the I0[Zn]/I0[Mg] ratio) is less than 2.0, the size of the precipitations is too small so that the precipitations do not contribute to the BH response.

In the meantime, if the average scattering intensity I0[Mg] is more than 5000 or the ratio of the average scattering intensity I0[Zn] to the average scattering intensity I0[Mg] ratio (the I0[Zn]/I0[Mg] ratio) is more than 50.0, the ductility is lowered.

About the ductility, in the aluminum alloy layer in which the Mg content by percentage is the largest, out of the aluminum alloy layers, work hardenability is increased by an effect of the solid-solutionized Mg atoms. Thus, the size or the production quantity of the clusters, which hinders the dislocation, may be small.

In the meantime, in the aluminum alloy layer in which the Zn content by percentage is the largest, the solid-solutionized Zn atoms do not contribute to the work hardenability improvement, this situation being different from that of Mg.

Thus, in the present invention, in the aluminum alloy layer in which the Zn content by percentage is the largest, the size or the production quantity of the clusters is controlled into an appropriate range, thereby exhibiting a cluster hardening effect to increase the work hardenability and improve the ductility.

Mainly in order that the aluminum alloy layer in which the Zn content by percentage is the largest can take charge of an effect of increasing the yield strength at the paint-bake-corresponding heat treatment (artificial aging) time, it is preferred in the aluminum alloy layer in which the Zn content by percentage is the largest to make the size and the production quantity of the produced clusters relatively large. The effect can be gained by controlling, into the specified range, each of the average inertial radius Rg and the average scattering intensity I0[Zn] of the central portion in the plate-thickness direction of the aluminum alloy layer in which the Zn content by percentage is the largest, out of the aluminum alloy layers.

### Precipitations to be Measured:

The precipitations to be measured by the small angle X-ray scattering technique, in the aluminum alloy clad structural member in the plate-thickness direction thereof, are mainly fine precipitations (clusters) made of Mg and Zn, which are main elements in the used aluminum alloy composition.

The precipitations are naturally varied in composition in accordance with the alloy composition of the aluminum alloy layers. The aluminum alloy layer in which the Mg content by percentage is the largest has a composition made mainly of Mg, and further containing Zn or none of Zn and containing (or not containing) the optional elements selectively in accordance with the alloy composition of the aluminum alloy layer.

The aluminum alloy layer in which the Zn content by percentage is the largest has a composition made mainly of Zn, and further containing Mg or none of Mg and containing (or not containing) the optional elements selectively in accordance with the alloy composition of the aluminum alloy layer.

In light of this point, it can be mentioned that the precipitations to be measured by the small angle X-ray scattering technique are entire precipitations (clusters) which are not discriminated from each other in accordance with the composition thereof, are contained in the aluminum alloy layers, and are measurable by a small angle X-ray scattering technique under conditions described below.

### Method for Measuring Precipitations by Small Angle X-Ray Scattering Technique:

Factors of the precipitations that are controlled in the present invention are the size and the number of precipitations (clusters) at a nanometer level, which is smaller than a micrometer level. Additionally, a subject of the present invention is the distribution state of the precipitations in each of the laminated aluminum alloy layers.

Specifically, in the present invention, the distribution state (change) of the precipitations in the plate-thickness (depth) direction of the aluminum alloy clad plate or the aluminum alloy clad structural member needs to be gained continuously at its depth positions (supposal points) that are at a regular pitch (at regular intervals).

For this purpose, it is preferred from the viewpoint of precision, reproducibility and measurement efficiency to use a small angle X-ray scattering technique out of various known measuring manners.

Hereinafter, a description will be made about methods for measuring or deriving the inertial radius Rg of the precipitations according to a small angle X-ray scattering technique, which represents the size of the precipitations in each of the aluminum alloy layers, and the scattering intensity I0 thereof, which represents the quantity of the precipitations in the aluminum alloy layer.

Under ordinary diffraction conditions (the scattering angle 2θ is in the range of values of 5 to 10°, or more), the size of a crystallite can be gained from a broadening of a diffraction peak satisfying Bragg's conditions. This is widely used in metallic material researches.

In contrast, a small angel X-ray scattering measurement is a typical method in which an X-ray is radiated onto a substance, and at the radiating time scattered X-rays are analyzed which are generated around the incident X-ray in the state that data on the density distribution of electrons inside the substance are reflected onto the incident X-ray, thereby examining particles present in the substance, or nanometer-order structural data having uneven densities.

About a metallic material such as an aluminum alloy, when fine precipitations in a nanometer order are present in the aluminum alloy, scatterings are generated around the incident X-ray correspondingly to an electron density difference between the matrix and the precipitations.

Regions where the scatterings are generated are regions having a scattering angle 20 in the range of values of 3 to 5°, or less. Characteristic scales (the average size, the shape, and data on their interfacial structures) that the scattering matters have can be precisely gained.

When a small angle X-ray scattering analysis is performed, a scattering vector q (or k or s is used instead of q in some literatures) (nm⁻¹) is used as a parameter corresponding to the scale of the actual space.

q=(4π×sin θ)/λ

wherein θ: the scattering angle (°), and λ: the wavelength (Å) of the X-ray.

In general, the inverse number of the magnitude of the scattering vector q corresponds approximately to the scale of the actual space. As described above, this scattering angle θ is in the range of 5° or less. The wavelength λ of the X-ray is varied in accordance with a used source for the X-ray. In the case of, for example, an X-ray having a wavelength of 1.54 Å, the scattering vector q is in the range of 7 nm⁻¹ or less. Moreover, according to the definition of the scattering vector q, as the q value is larger, data on a smaller scale can be gained so that data can be further gained on the size, the shape and the dispersion situation of scattering matters (such as particles or density variations) having a size from several angstroms to several tens of nanometers.

In particular, data on the size of particles are reflected onto a scattering intensity profile of regions where the scattering vector q is small. When a particle is presumed to be spherical in a region where the scattering vector is small, the scattering intensity profile Iq, the inertial radius (or the gyration radius) Rg of the particle, and the scattering intensity I0 are represented by the following equation:

Iq=10×exp(−Rg²×q²/3)

wherein I0: V²[ρ(r)−ρ0]² when the particle is homogenous.

V represents the volume of the particle; ρ(r), the electron density of the particle; and ρ0, the average electron density of the matrix. When particles are of the same kind, the respective electron densities of the particles are constant, so that the value of “ρ(r)−ρ0”, which is the electron density difference between the particles and the matrix is a constant number. Accordingly, I0 is in proportion to the square of the volume of the particles. From this value, the quantity of the particles can be estimated.

According to the equation, when the logarithm of Iq (ln {Iq}) and q² are plotted, the inertial radius Rg and I0 can be gained from the gradient of the resultant line, and the intercept, respectively.

The range of q in which the logarithm of Iq (ln {Iq}) and q² are plotted to gain the inertial radius Rg is usually a range of q in which the product of q and Rg is 2 or less.

When the precipitations are spheres each having a radius R, R and the inertial radius Rg satisfy the following relationship therebetween:

Rg²=3/5×R².

Thus, when the precipitations are spheres, an actual size of the Precipitations can be estimated from the inertial radius. At this time, R is called the Guinier radius.

### X-Ray Scattering Intensity Profile:

As described above, in order to derive the inertial radius Rg and the scattering intensity I0 of the precipitations by a small angle X-ray scattering technique, an X-ray scattering intensity profile of each of the aluminum alloy layers, which is measured by the small angle X-ray scattering technique, is gained.

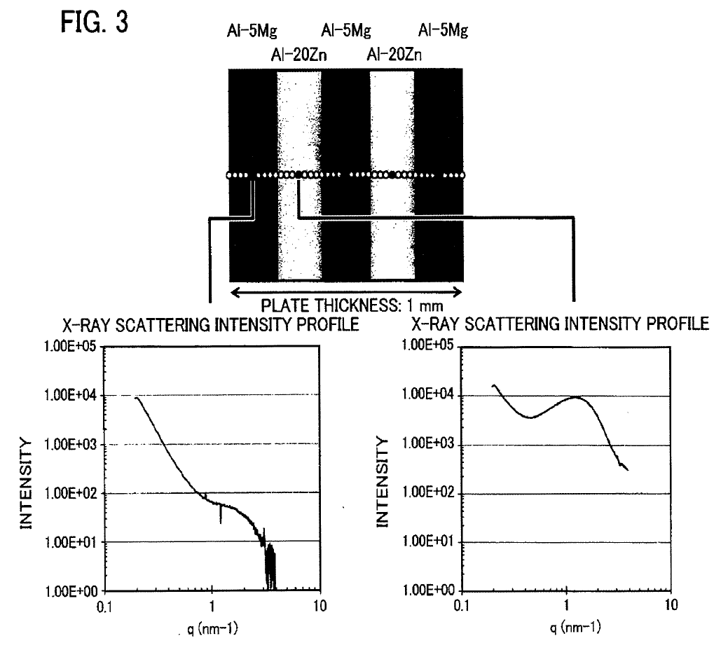

In FIG. 3 are shown measuring points in the plate-thickness (thickness) direction of individual aluminum alloy layers, and an X-ray scattering intensity profile measured in these measuring points by a small angle X-ray scattering technique. FIG. 3 is a view of Invention Example 6 in Table 2, which will be described later.

As seen in the upper-side sub-view in FIG. 3, about the aluminum alloy layers to be measured, its lateral direction represents a direction along which the individual layers are put onto each other, or the plate-thickness (depth) direction, and its vertical direction represents a direction along which the aluminum alloy layers are widened.

The clad plate shown in the upper-side sub-view, is a clad plate (simulating a clad structural member after subjected to diffusion heat treatment) totally having 5 layers obtained by laminating the following: Al-5Mg aluminum alloy layers in which Mg is contained in a proportion of 5% by mass so that the Mg content by percentage is the largest (three layers in total: both-side two outermost layers, and one central layer); and Al-20Zn aluminum alloy layers in which Zn is contained in a proportion of 20% by mass so that the Zn content by percentage is the largest (two layers in total: two layers each sandwiched between two of the Al-5Mg aluminum alloy layers). The thickness of the clad plate is 1 mm.

As shown in the upper side sub-view, the measuring points, along which a line passing through respective plate-thickness-central portions of the aluminum alloy layers, are represented by a sequence of circular marks. The respective plate-thickness-central portions of the layers are represented by black dots.

In FIG. 3, the right-side sub-view shows the X-ray scattering intensity profile of the plate-thickness-central portions of the Al-20Zn aluminum alloy layers, and the left-side sub-view shows the X-ray scattering intensity profile of the plate-thickness-central portions of the Al-5Mg aluminum alloy layers. Their vertical axes represent the scattering intensity (the scattering intensity of the scattered X-rays), and their lateral axes represent the scattering vector (q/nm⁻¹).

In FIG. 3, about the X-ray scattering intensity profile of the plate-thickness-central portions of the Al-20Zn aluminum alloy layers in the right-side sub-view, the scattering vector on the lateral axis is larger toward the left and is smaller toward the right.

In the right-side sub-view, it is understood that on a ridge line right relative to an X-ray scattering intensity peak at which the scattering vector on the lateral axis is near to 0.1 q/nm⁻¹, values on this line being decreased from the value of this peak, there is an upward convex peak between scattering vectors of about 0.5 q/nm⁻¹ and 3 q/nm⁻¹ on the lateral axis. In other words, the ridge line shape in the right-side sub-view has the convex peak of clusters, which results from Zn, so that at this portion the line rises once, and then lowers toward the right of FIG. 3.

In contrast, the left-side sub-view shows the X-ray scattering intensity profile of the plate-thickness-central portions of the Al-5 Mg aluminum alloy layers. The shape of a ridge line in such a case, where the alloy does not contain Zn, in a range where the scattering vector on the lateral axis is larger (range from about 0.8 to 4 q/nm⁻¹), an upward convex peak in the sub-view is recognized.

In each of the range between the scattering vectors of about 0.5 q/nm⁻¹ and 3 q/nm⁻¹ on the lateral axis in the right-side sub-view of FIG. 3, and the range between the vectors of about 0.8 q/nm⁻¹ and 4 q/nm⁻¹ in the left-side sub-view of FIG. 3, the upward convex peak is generated. The reason therefor is that Zn based clusters are present, and the middles between the Zn based clusters, or the Zn based clusters interfere with each other.

The Zn based clusters are Zn clusters in which the η phase, θ phase and T phase, and some other already known phase are still present in a metastable state. Thus, X-ray scattering intensity peaks as shown in the sub-views demonstrate the presence of Zn clusters.

As an analyzing method (analyzing software) of analyzing the X-ray scattering intensity profiles in FIG. 3 to gain the inertial radii Rg and the scattering intensities of Mg and Zn clusters (precipitations), a known analyzing method according to, for example, Schmidtrani et al. (see I. S. Fedorova and P. Schmidt: J. Appl. Cryst. 11, 405, 1978) is used.

The above-mentioned method for gaining the inertial radius Rg and the scattering intensity I0 of Zn clusters (precipitations) are described in Koji Okuda, The Crystallographic Society of Japan, vol. 41, No. 6 (1999), pp. 327-334, Hideki Matsuoka, The Crystallographic Society of Japan, vol. 41, No. 4 (1999), pp. 213-226, Masato Ohnuma, Kinzoku (Materials Science & Technology), vol. 73, No. 12 (2003), pp. 1233-1240, or Masato Ohnuma, Kinzoku (Materials Science & Technology), vol. 74, No. 1 (2004), pp. 79-86, which describe a quantitative determination method of characteristic scales (the average size, the shape, and interfacial structure data) of precipitations from an X-ray scattering intensity profile of a metal.

### Particle Size Distribution of Fine Precipitations (MgZn Clusters):

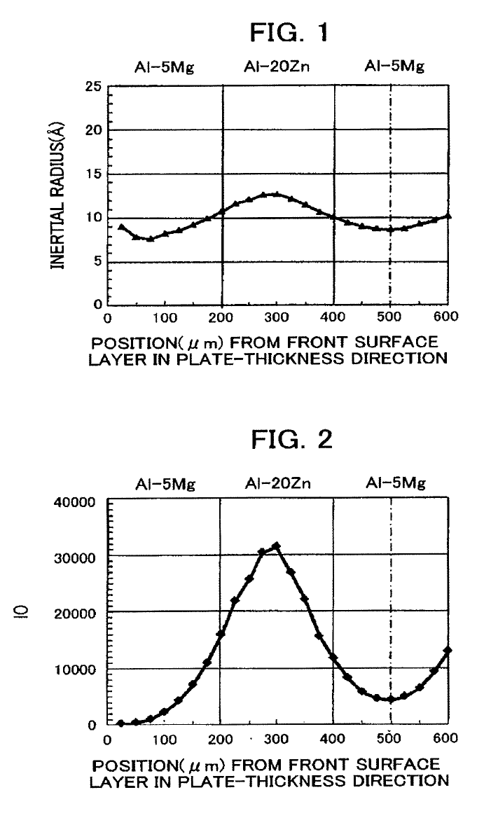

FIGS. 1 and 2 show, respectively, the inertial radius Rg and the scattering intensity I0 of the precipitations (Mg and Zn clusters) that were obtained by analyzing the X-ray scattering intensity profiles in FIG. 3.

In FIG. 1, its vertical axis represents the inertial radius Rg, and in FIG. 2, its vertical axis represents the scattering intensity I0. Their lateral axes each represent the positions (measuring points) in the plate-thickness (depth) direction of the five aluminum alloy layers inwards from their surface layer, the positions being shown in the upper-side sub-view of FIG. 3.

In each of FIGS. 1 and 2, points represented by a vertical dot line represent the plate-thickens-center of the whole of the five aluminum alloy layers. According to FIGS. 1 and 2, an analysis was made about a region of the five aluminum alloy layers laminated bisymmetrically to the plate-thickness-center, this region extending down to the plate-thickness-center of these layers, that is, down to a depth (600 μm) of an approximate half of the plate thickness (1 mm) of the whole.

In the case of aluminum alloy layers laminated bisymmetrically to the plate-thickness-center of the whole in such a way, the other half also gives substantially the same measured results. It is therefore advisable to analyze the region extending to the vicinity of the plate-thickness center of the whole, that is, the region extending to a depth (thickness) of the vicinity of an approximate half of the plate thickness of the whole. In light of this point, in the case of aluminum alloy layers laminated left-right asymmetrically to the plate-thickness-center of the whole, it is preferred to analyze these layers comprehensively over the plate thickness of the whole thereof.

### Artificial Aging:

In order to make the aluminum alloy clad plate or aluminum alloy clad structural member, which has the above-mentioned microstructure (microstructure subjected to the diffusion heat treatment), into a higher strength necessary for a structural member of automobiles and others, the plate or member is preferably subjected to artificial aging, or to paint-bake hardening treatment after the plate is painted to form the structural member.

In this way, increases are made about the size (inertial radius Rg) of the precipitations in the aluminum alloy layers and the quantity (scattering intensity I0) of the precipitations, these factors being each specified in the present invention and being according to the small angle X-ray scattering technique, so that the clad plate or the structural member attains a high strength necessary for constructions.

In the present invention, a criterion of the high strength is a 0.2%-yield-strength of 400 MPa or more as the strength of the clad plate after the artificial aging (paint-bake hardening).

For reference, in the present invention, as the artificial aging for gaining such a high strength, unnecessary is an artificial aging at a low temperature for a long period, for example, at 120° C. for 24 hours in the same manner as in the case of an ordinary single Al—Zn alloy plate (7000 series alloy plate).

In the invention, the necessary high strength can be sufficiently gained by a paint-bake hardening treatment (artificial aging) made high in temperature and short in period, for example, a treatment at 160 to 205° C. for 20 to 40 minutes, the treatment being applied to the current structural members of automobiles and others after the members are painted.

Thus, the invention also has a great advantage that artificial aging at a high temperature for a long period can be omitted.

The mutual diffusion phase of Mg and Zn elements, and the average crystal grain size of the aluminum alloy layers, which are specified in the aluminum alloy clad plate or structural member of the present invention, are hardly changed by artificial aging under such conditions. Thus, the thickness of the mutual diffusion phase of Mg and Zn elements, and the average crystal grain size of the aluminum alloy layers, which are specified in the aluminum alloy clad plate or structural member of the invention, may be measured after the diffusion heat treatment, or after the artificial aging following this diffusion heat treatment.

### EXAMPLES

Hereinafter, the present invention will be more specifically described by way of working examples thereof.

Aluminum alloy clad plates were produced in which plural aluminum alloy layers were laminated onto each other, and then subjected to diffusion heat treatment so that the laminated aluminum alloy layers were made different from each other in mutual diffusion regions of Mg and Zn. These were compared with each other about the formability (ductility) and the strength thereof. These results are shown in Table 2.

The production of the aluminum alloy clad plates was specifically as follows:

Aluminum alloy ingots having respective alloy compositions A to L shown in Table 1 were melted and cast. The resultants were separately from each other subjected to homogenization, hot rolling, and optional cold rolling to produce plate materials having the respective compositions, and having the same plate thickness of 1 mm to render the respective clad ratios of the laminated layers of each of the elate materials ratios equal to each other, which each corresponded to the number of the laminated layers.

Each combination of plate materials that is shown in Table 2, out of these plate materials, was used, and the combined plate materials were laminated onto each other. The resultant laminated plate was re-heated at 400° C. for 30 minutes, and then made into a clad plate by a rolling clad method in which hot rolling was started at the temperature.

The resultant respective clad plates in the individual examples were further cold-rolled while subjected to process annealing at 400° C. for 1 second. Under the individual conditions shown in Table 2, the resultants were subjected to diffusion heat treatment to prepare clad plates having respective clad plate thicknesses (each of the thicknesses was the total thickness of the individual layers) shown in Table 2.

When the total plate thickness of the whole of each of these finally obtained clad plates was from 1 to 5 mm, the thickness of each of the laminated alloy plates ranged from about 0.1 to 2.0 mm (100 to 2000 μm). About the respective clad ratios of these cladded plates, each of the plates was produced to make the respective thicknesses (clad ratios) of its aluminum alloy layers equal to each other.

In the diffusion heat treatment, the average temperature-raising rate was set to 4° C./minute, commonly to the examples. In each of the examples, an end-point temperature (° C.) of the clad plate, and a holding period (hr) were used. Immediately after the holding over this predetermined period, the plate was cooled at one (° C./second) out of various cooling rates shown in Table 2.

In a column “Multilayered aluminum alloy clad plate” in Table 2 are shown the average content by percentage of each of Mg and Zn in the whole of each of the aluminum alloy clad plates; the total number of the laminated layers in each of the plates in Table L and the thickness of the plate. Moreover, as each combination of the laminated layers, used species out of the aluminum alloy layers A to L species shown in Table 1 are shown successively from the top side to the bottom side of the laminate.

In any one of the clad plates in which layers in odd number, such as 5, 11, or 13 layers, were laminated onto each other in the order of, for example, ADADA, BEBEB or CFCFC, the aluminum alloy layer in which the Mg content by percentage was the largest, such as A, B or C in Table 1, was laminated as each of the two outside (top side and bottom side) layers of the clad plate. The aluminum alloy layer in which the Zn content by percentage was the largest, such as D, E, F, G, H or I in Table 1, was laminated as each layer inside the clad plate.

The content by percentage of each of Mg and Zn, which was an average proportion in each of the aluminum alloy clad plates shown in Table 2, was calculated out as the weighted arithmetical average value in the state of rendering the respective clad ratios of the aluminum alloy layers wholly ratios equal to each other correspondingly to the number of the laminated layers since the respective thicknesses of the aluminum alloy layers (plates) were equal to each other.

A sample was collected from any moiety of each of the produced aluminum alloy clad plates (obtained after the diffusion heat treatment). About this sample, measurements were made about mutual diffusion regions, the average crystal grain size of respective plate-thickness-central portions of the laminated aluminum alloy layers, and respective distributions in the plate-thickness direction of the average inertial radius Rg and the average scattering intensity I0 each measured by a small angle X-ray scattering technique.

The elongation (%) of this sample was also examined by a tension test at room temperature, which will be detailed later. The results are shown in Table 2.

### Mutual Diffusion Regions of Mg and Zn:

An electron ray micro analyzer (EPMA) was used to measure the concentration of each of Mg and Zn in the plate-thickness direction in a cross section in the plate-thickness direction of each of five samples collected from five arbitrary sites in the width direction of the clad plate of each of the examples, so that all of the invention examples and comparative examples had mutual diffusion regions of Mg and Zn.

In FIG. 6 is shown, as an example, mutual diffusion regions of Mg and Zn in the plate-thickness direction of a case where the aluminum alloy layers A and D in Table 1 were combined with each other to be configured as Invention Example 2 (ADADADADADA) in Table 2, which had 11 layers as an example of equivalent to the example of the combination pattern illustrated in FIG. 4.

In FIG. 6, its lateral axis represents each of sites of the clad plate from the front surface (0 μm) to the rear surface (1000 μm) thereof, this plate being extended over plate thicknesses from 0 to 1000 μm (1 mm); its vertical axis represents the concentration of each of Mg and Zn (content by percentage: % by mass); and a line having high peaks represents the content of Zn and a line having low peaks represents that of Mg.

In FIG. 6, regions where the Mg concentration were the highest show regions of the aluminum alloy layers A in Table 1 (before the clad was subjected to diffusion heat treatment); and regions where the Zn concentration were the highest, regions of the aluminum alloy layers D in Table 1 (before the clad was subjected to diffusion heat treatment). Other regions, which each had an inclined Mg or Zn concentration, show mutual diffusion regions of Mg and Zn.

For reference, in FIG. 6, about the largest value of the content by percentage of each of Mg and Zn in the aluminum alloy layers before the diffusion heat treatment, the Mg content in the aluminum alloy layers A in Table 1 was 5.0% by mass, and the Zn content in the aluminum alloy layers D in Table 1 was 20.0% by mass.

### Average Crystal Grain Size:

The average crystal grain size of crystals in each of the laminated aluminum alloy layers of any one of the above-mentioned samples was measured. Specifically, initially, about the same cross section in the plate-thickness-central portion of each of the entire laminated aluminum alloy layers as measured about the Mg and Zn concentration distributions, five visual fields thereof were observed through an optical microscope of a magnifying power of 100. The average crystal grain size in the plate-thickness-central portion of each of the aluminum alloy layers was measured. About the respective average crystal grain sizes of the plate-thickness-central portions of these individual aluminum alloy layers, which were all of the laminated aluminum alloy layers, the weighted arithmetic average thereof was calculated out. The resultant value was defined as the “average crystal grain size (μm) of the respective crystals in the individual laminated aluminum alloy layers, which is obtained by averaging the respective grain sizes of the crystals”, this size being specified in claim 1. The results are shown in Table 2.

### Distribution State in Plate-Thickness Direction of Precipitations:

As indexes representing the distribution state in the plate-thickness direction of the precipitations in each of the above-mentioned samples, the average inertial radius Rg of the precipitations in each of the aluminum alloy layers, and the average scattering intensity JO thereof were measured by a small angle X-ray scattering technique.

Commonly to the individual examples, in the measurements by the small angle X-ray scattering technique, a used test machine was a machine “BL40XU” in the “Spring-8” in Japan, and a used X-ray was an X-ray having an energy of 15 keV. As a micro beam through a non-scattering slit of 5 μm and 5 μm size, the X-ray was radiated onto the front surface of a test specimen produced from the sample.

Out of the scattered X-rays from the test specimen, a scattered X-ray having a micro angle of 5 degrees or less was measured through a two-dimensional CCD detector. A cross section in the plate thickens direction of the sample was successively measured over a range from a single side thereof, which was the front layer side thereof, to the rear surface side, which was opposite to the former side, at intervals of 25 μm in the plate-thickness direction. In this way, the X-ray scattering intensity profile of the specimen was gained.

From the obtained scattering intensity profile, measurements were made about the inertial radius Rg of a plate-thickness-direction central portion of an aluminum alloy layer in which the Mg content by percentage was the largest, out of the aluminum alloy layers, and the inertial radius Rg of a plate-thickness-direction central portion of an aluminum alloy layer in which the Zn content by percentage was the largest, out of the aluminum alloy layers. Moreover, measurements were made about the scattering intensity I0[Mg] of the aluminum alloy layer in which the Mg content by percentage was the largest, and the scattering intensity I0[Zn] of the aluminum alloy layer in which the Zn content by percentage was the largest.

The measurements were made about the five samples collected from the arbitrary sites of the produced aluminum alloy clad plate (subjected to the diffusion heat treatment). The resultant inertial radii Rg of the five samples, as well as the scattering intensities I0[Mg] and the scattering intensities I0[Zn], were averaged into the average inertial radius Rg, as well as into the average scattering intensity I0[Mg] and the average scattering intensity I0[Zn].

### BH Response:

Furthermore, each of the produced aluminum alloy clad plates (subjected to the diffusion heat treatment) was kept at room temperature for one week, and then subjected to a short-period artificial aging treatment (T6 treatment) at 180° C. for 30 minutes. The 0.2%-yield-strength of the aluminum alloy clad plate after the T6 treatment was also examined. These results are also shown in Table 2.

In each of the examples, test specimens thereof were each worked into a JIS #5 test piece, and subjected to a tensile test at room temperature to make the pulling direction thereof parallel to the rolling direction to measure the 0.2%-yield-strength (MPa). The tensile test was made according to JIS 2241 (1980) at a room temperature of 20° C., a constant tensile speed of 5 mm/minute, and a distance of 50 mm between the specimen-supporting points until the test specimen was broken. In this manner, the entire elongation (%) of the clad plate before the T6 treatment was also measured.

In each of Invention Examples 1 to 12 in Table 2, the laminated aluminum alloy layers have, as a composition for the diffusion heat treatment, an alloy composition in the specified alloy range. The average content by percentage of each of Mg and Zn in the aluminum alloy clad plate is also in the specified range. Moreover, the aluminum alloy layers D, E, F, G, H, I and/or J each containing Zn in the specified content range are laminated inside the clad plate, and the outermost aluminum alloy layers A, B and/or C have a composition containing Mg in a range of 3 to 10% by mass and further Zn in a restrained range of 2% or less by mass (including 0% by mass).

These aluminum alloy layers are laminated onto each other to join the aluminum alloy layers to each other to make any adjacent two thereof different from each other in Mg or Zn content by percentage, set the total number of the laminated layers into the specified-number range of 5 to 13, and set the total plate thickness into the specified range.

Furthermore, Invention Examples 1 to 12 each have, as an aluminum alloy clad plate after the diffusion heat treatment under appropriate conditions, an average crystal grain size of the laminated aluminum alloy layers that is 200 μm or less, and has mutual diffusion regions of Mg and Zn. Furthermore, as the indexes representing in the plate-thickness direction of the precipitations, the average inertial radius Rg and the average scattering intensity JO of the precipitations in the individual aluminum alloy layers each satisfy the requirement.

As a result, the entire elongation of each of the produced clad plates of the invention examples (before the T6 treatment) is 17% or more to show a high formidability. The 0.2%-yield-strength thereof after the BH, about which it is supposed that the aluminum alloy clad plate is subjected to artificial aging treatment after press-formed into a structural member, is 400 MPa or more to show a high strength.

When any raw material clad plate is press-formed into an automobile structural member, it is acceptable that the entire elongation thereof is 17% or more. Moreover, in a case where this aluminum alloy clad plate is subjected to a short-period artificial aging treatment at 180° C. for 30 minutes which simulates (corresponds to) treatment for automobile structural members, it is allowable that the 0.2%-yield-strength thereof after the artificial aging treatment is 400 MPa or more.

By contrast, about Comparative Examples 13 to 22 in Table 2, the number of the laminated aluminum alloy layers or the composition thereof does not satisfy the specified requirement, or the diffusion heat treatment conditions therefor do not satisfy the preferred range even when the examples satisfy the number and the composition. Thus, about these comparative examples, the average composition of the laminated aluminum alloy layer, the average crystal grain size, the average inertial radius Rg and the average scattering intensity I0 of each of the aluminum alloy layers, and/or some other factor is/are out of the (respective) specified range(s).

As a result, about these comparative examples, the elongation of their clad plate after the production thereof does not satisfy 17%, or the 0.2%-yield-strength after the artificial aging treatment is less than 400 MPa to be too low, so that the clad plate cannot have both a high strength and formability, and a high BH response.

In Comparative Example 13, the number of the laminated layers is 3 to be too small.

In Comparative Examples 14 to 16, and 22, the diffusion heat treatment conditions are out of the preferred range. The temperature is too low (Comparative Examples 14 and 22) and the holding period is too short (Comparative Example 15) or too long (Comparative Example 16).

In Comparative Examples 17 to 19, the cooling conditions after the diffusion heat treatment are out of the preferred range. The first stage cooling rate is too small (Comparative Examples 17, 18 and 19), and the second stage cooling rate is too large (Comparative Examples 18 and 19).

In Comparative Examples 20 and 21, the composition of the laminated aluminum alloy layers is out of the range specified in the present invention. In each of Comparative Examples 20 and 21, the Mg content by percentage in the alloy composition K, or the Zn content by percentage in the alloy composition L is too small.

TABLE 1

| | | Component (% by mass) composition of aluminum alloy layers to be laminated (the balance: Al) | | | | | | | |
|---|---|---|---|---|---|---|---|---|---|
| Abbreviation | Alloy species | Mg | Zn | Cu | Si | Fe | Zr | Ag | Ti |
| A | Al-Mg binary | 5.0 | — | — | — | — | — | — | — |
| B | Al-Mg binary | 5.0 | — | — | 0.1 | 0.1 | 0.06 | — | 0.01 |
| C | Al-Mg binary | 8.0 | — | — | 0.05 | 0.1 | 0.15 | — | 0.01 |
| D | Al-Zn binary | — | 20.0 | — | — | — | — | — | — |
| E | Al-Zn binary | — | 10.0 | 2.0 | 0.05 | 0.05 | 0.06 | — | 0.0 |
| F | Al-Zn binary | — | 20.0 | 1.0 | 0.2 | 0.1 | 0.08 | — | 0.01 |
| G | Al-Zn binary | — | 20.0 | 3.0 | 0.2 | 0.1 | 0.10 | — | 0.01 |
| H | Al-Zn binary | — | 20.0 | 1.0 | 0.2 | 0.1 | 0.08 | 0.7 | 0.01 |
| I | Al-Zn binary | — | 25.0 | — | 0.1 | 0.15 | 0.08 | — | 0.01 |
| J | Zn-Mg ternary | 1.0 | 20.0 | 0.5 | 0.1 | 0.10 | 0.10 | — | 0.01 |
| K | Al-Mg binary | 2.0 | — | — | 0.1 | 0.1 | — | — | 0.01 |
| L | Al-Zn binary | — | 4.0 | 0.2 | 0.1 | 0.1 | — | — | 0.01 |

Any symbol “-” in the table demonstrates that the quantity of the corresponding element is the detection limit or less, and is substantially 0% by mass.

TABLE 2

| | | | | | | | | | | | | | | | | | Aluminum | |
|---|---|---|---|---|---|---|---|---|---|---|---|---|---|---|---|---|---|---|
| | | | | | | | | | | | | | | | | | alloy dad plate | |
| | | | | | | | | | | | | | | | | | characteristics | |
| | | | | | | | | | | | | | | | | | | 0.2%- |
| | | | | | | | | | | | | | | | | | | Yield- |
| | | | | | | | | | | | | | | | | | | strength |
| | | | | | | | | | | | | | | | | | | (MPa) |
| | | | | | | | | | | | | | | | | | | after |
| | | | | | | | | | | | | | | | | | | paint- |
| | | | | | | | | Aluminum alloy dad plate composition and microstructure | | | | | | | | | | bake |
| | | | | | Producing conditions | | | | | | | | | | Scattering | | | corre- |
| | | | | | | Cooling conditions | | | | | | | | | intensity | | | spond- |
| | | | | | | Average | | | | | | | | | Alum- | | | ing |
| | | | | | | cooling | | | | | | | | | inum | | | heat |
| | | | | | | rate | Average | | | Alum- | | | | | alloy | | | treat- |
| | | Aluminum alloy dad plate | | | | (° C./s) | cooling | | | inum | Inertial radii | | | | layer | | | ment |
| | | | | Combination | | from | rate | | | alloy | Aluminum alloy | | Aluminum alloy | | in | | | (heat- |
| | | The | | of some | Diffusion | diffusion | (° C./s) | | | layers | layer in which | | layer in which | | which | | | ing |
| | | number | | of alloy | heat | heat | from | Average | | Average | Mg content | | Zn content | | Mg | | | at |
| | | of | | layers in | treament | treatment | 100° C. | proportions | | crystal | is the largest | | is the largest | | content | | | 180° |
| | | laminated | | Table 1 | conditions | temper- | to | (% by mass) | | grain | | Inertial | | Inertial | is the | \|0 | Entire | C. |
| | | aluminum | Plate | (laminating order | Temperature | ature | room | Mg | Zn | dia- | Layer | radius | Layer | radius | largest | [Zn]/ | elong- | for 30 |
| Classi- | | alloy | thickness | from top side | (° C.) × holding | to | temper- | pro- | pro- | meter | abbrev- | Rg | abbrev- | Rg | \|(0) | \|0 | ation | min- |
| fication | No. | layers | (mm) | to bottom side) | period (hr) | 100° C. | ature | portion | portion | (μm) | iation | (nm) | iation | (nm) | [Mg] | [Mg] | (%) | utes) |
| Inven- | 1 | 5 | 1.0 | ADADA | 470° C. × 5 hr | 40 | 30 | 3.00 | 8.00 | 196 | A | 0.6 | D | 1.6 | 3379 | 3.6 | 17 | 406 |
| tion | 2 | 11 | 1.0 | ADADADADADA | 500° C. × 0.5 hr | 55 | 25 | 2.73 | 9.10 | 192 | A | 0.9 | D | 1.5 | 3523 | 3.2 | 17 | 402 |
| Exam- | 3 | 13 | 1.0 | ADADADADADADA | 48C° C. × 2.5 hr | 50 | 28 | 2.69 | 9.23 | 188 | A | 1.0 | D | 1.6 | 3215 | 8.5 | 17 | 473 |
| ple | 4 | 5 | 1.0 | CFCFC | 460° C. × 10 hr | 35 | 30 | 4.80 | 8.00 | 84 | C | 0.9 | F | 1.8 | 2981 | 8.2 | 18 | 421 |
| | 5 | 5 | 1.0 | BEBEB | 520° C. × 2 hr | 55 | 30 | 3.00 | 4.00 | 139 | B | 0.9 | E | 1.1 | 3109 | 2.4 | 18 | 400 |
| | 6 | 5 | 1.0 | BFBFB | 470° C. × 7 hr | 60 | 20 | 3.00 | 8.00 | 134 | B | 0.8 | F | 1.3 | 2794 | 21.7 | 19 | 458 |
| | 7 | 13 | 1.0 | BFBFBFBFBFBFB | 480° C. × 3 hr | 80 | 18 | 2.69 | 9.23 | 117 | B | 1.9 | F | 2.1 | 2729 | 27.5 | 19 | 460 |
| | 8 | 11 | 1.0 | BGBGBGBGBGB | 460° C. × 12 hr | 95 | 20 | 2.73 | 9.10 | 104 | B | 2.1 | G | 2.2 | 2641 | 25.8 | 18 | 462 |
| | 9 | 5 | 1.0 | BHBHB | 500° C. × 1 hr | 90 | 15 | 3.00 | 8.00 | 113 | B | 2.2 | H | 2.4 | 2706 | 26.9 | 19 | 465 |
| | 10 | 5 | 1.0 | BIBIB | 470° C. × 6 hr | 100 | 12 | 3.00 | 10.00 | 125 | B | 1.9 | H | 3.3 | 4881 | 32.4 | 17 | 537 |
| | 11 | 11 | 2.0 | BIBIBIBIBIB | 460° C. × 24 hr | 65 | 30 | 2.70 | 11.40 | 97 | B | 1.6 | H | 2.1 | 3479 | 19.4 | 17 | 455 |
| | 12 | 5 | 1.0 | BJBJB | 475° C. × 4 hr | 120 | 30 | 3.40 | 8.00 | 109 | B | 1.1 | J | 2.5 | 3324 | 23.2 | 18 | 471 |
| Compar- | 13 | 3 | 1.0 | ADA | 470° C. × 6 hr | 40 | 30 | 3.33 | 6.67 | 251 | A | 0.6 | D | 1.5 | 5386 | 1.8 | 15 | 363 |
| ative | 14 | 5 | 1.0 | BFBFB | 430° C. × 6 hr | 40 | 30 | 3.00 | 8.00 | 82 | B | 0.2 | F | 1.1 | 3315 | 1.7 | 17 | 357 |
| Exam- | 15 | 11 | 1.0 | BFBFBFBFBFB | 470° C. × 0.1 hr | 40 | 30 | 2.73 | 9.10 | 67 | B | 0.2 | F | 1.0 | 2857 | 1.6 | 17 | 344 |
| ple | 16 | 13 | 1.0 | BFEFBFEFBFBFB | 500° C. × 105 hr | 40 | 30 | 2.69 | 9.23 | 236 | B | 2.3 | F | 2.8 | 13916 | 2.1 | 12 | 416 |
| | 17 | 5 | 2.0 | BHBHB | 480° C. × 8 hr | 20 | 20 | 3.00 | 8.00 | 144 | B | 0.7 | H | 1.4 | 2793 | 1.9 | 17 | 378 |
| | 18 | 11 | 2.0 | BHBHBPHBHB | 480° C. × 16 hr | 30 | 40 | 2.73 | 9.10 | 152 | B | 0.6 | H | 1.3 | 2638 | 1.8 | 17 | 356 |
| | 19 | 13 | 3.0 | BHBHBHBHBHBHB | 470° C. × 24 hr | 15 | 50 | 2.69 | 9.23 | 137 | B | 0.5 | H | 1.2 | 2210 | 1.5 | 17 | 304 |
| | 20 | 5 | 2.0 | KLKLK | 490° C. × 8 hr | 40 | 30 | 1.20 | 1.60 | 193 | J | 0.2 | K | 0.7 | 1038 | 1.2 | 19 | 186 |
| | 21 | 5 | 1.0 | BLBLB | 500° C. × 3 hr | 40 | 30 | 3.00 | 1.60 | 179 | B | 0.3 | K | 0.9 | 1753 | 1.6 | 19 | 193 |
| | 22 | 5 | 1.0 | BJBJB | 435° C. × 12 hr | 60 | 20 | 3.40 | 8.00 | 85 | B | 0.2 | J | 0.8 | 2144 | 1.4 | 11 | 295 |

These working examples support the significances of the individual requirements of the present invention for producing an aluminum alloy clad plate having both of a high strength and formability, and a high BH response, and an aluminum alloy clad structural member having both of a high strength and ductility, and a high BH response.

The present invention can solve an incompatibility of a high strength level of any conventional simple plate made of, for example, a 7000 series aluminum alloy with the ductility thereof to provide an aluminum alloy clad plate having both of a high strength and a high formability (ductility) even through a high-temperature and short-period artificial aging, or an aluminum alloy clad structural member obtained by forming this clad plate into a shape.

What is claimed is:

1. An aluminum alloy clad plate high in strength and formability, and excellent in BH response, comprising a plurality of aluminum alloy layers;
out of the aluminum alloy layers, aluminum alloy layers inside outermost aluminum alloy layers of the aluminum alloy clad plate each comprising one or two of Mg in a proportion of 3 to 10% by mass, and Zn in a proportion of 5 to 30%© by mass;
the outmost aluminum alloy layers each comprising Mg in a proportion ranging from 3 to 10% by mass, and Zn in a restrained proportion of 2% or less by mass (the proportion including 0% by mass);
any adjacent two of these aluminum alloy layers being different from each other in content by percentage of Mg or Zn therein, the total number of the aluminum alloy layers laminated onto each other being from 5 to 15, and the whole of the aluminum alloy layers having a total plate thickness of 1 to 5 mm;
about the average content by percentage of each of Mg and Zn in the aluminum alloy clad plate, the content of Mg being from 2 to 8% by mass, and the content of Zn being from 3 to 20% by mass, these contents being each a value obtained by averaging the respective Mg contents or Zn contents by percentage in the laminated aluminum alloy layers;
the aluminum alloy clad plate having a microstructure in which the average crystal grain size of respective crystals in the individual laminated aluminum alloy layers, which is obtained by averaging the respective grain sizes of the crystals, is 200 μm or less, and further in which mutual diffusion regions of Mg and Zn are present where Mg and Zn are mutually diffused between the laminated aluminum alloy layers;
about indexes each representing a distribution state in the plate-thickness direction of precipitations in the aluminum alloy clad plate,
one of these indexes being the inertial radius Rg of the precipitations which represents the size of the precipitations in each of the aluminum alloy layers and is measured by a small angle X-ray scattering technique, a central portion in the plate-thickness direction of an aluminum alloy layer in which the Mg content by percentage is the largest, out of the aluminum alloy layers, having an average inertial radius Rg ranging from 0.3 to 2.0 nm, and a central portion in the plate-thickness direction of an aluminum alloy layer in which the Zn content by percentage is the largest, out of the aluminum alloy layers, having an average inertial radius Rg ranging from 1.0 to 3.0 nm; and
another of the indexes being the scattering intensity I0 of the precipitations which represents the quantity of the precipitations in each of the aluminum alloy layers and is measured by the small angle X-ray scattering technique, the central portion in the plate-thickness direction of the aluminum alloy layer in which the Mg content by percentage is the largest, out of the aluminum alloy layers, having an average scattering intensity I0[Mg] ranging from 1000 to 5000, and the ratio of the average scattering intensity I0[Zn] of the central portion in the plate-thickness direction of the aluminum alloy layer in which the Zn content by percentage is the largest, out of the aluminum alloy layers, to the average scattering intensity I0[Mg] (the I0[Zn]/I0[Mg] ratio) ranging from 2.0 to 50.0.

2. An aluminum alloy clad structural member high in strength and ductility, and excellent in BH response, comprising a plurality of aluminum alloy layers;
out of the aluminum alloy layers, aluminum alloy layers inside outermost aluminum alloy layers of the aluminum alloy clad structural member each comprising one or two of Mg in a proportion of 3 to 10% by mass, and Zn in a proportion of 5 to 30% by mass;
the outmost aluminum alloy layers each comprising Mg in a proportion ranging from 3 to 10% by mass, and Zn in a restrained proportion of 2% or less by mass (the proportion including 0%© by mass);
any adjacent two of these aluminum alloy layers being different from each other in content by percentage of Mg or Zn therein, the total number of the aluminum alloy layers laminated onto each other being from 5 to 15, and the whole of the aluminum alloy layers having a total plate thickness of 1 to 5 mm;
about the average content by percentage of each of Mg and Zn in the aluminum alloy clad structural member, the content of Mg being from 2 to 8% by mass, and the content of Zn being from 3 to 20% by mass, these contents being each a value obtained by averaging the respective Mg contents or Zn contents by percentage in the laminated aluminum alloy layers;
the aluminum alloy clad structural member having a microstructure in which the average crystal grain size of respective crystals in the individual laminated aluminum alloy layers, which is obtained by averaging the respective grain sizes of the crystals, is 200 μm or less, and further in which mutual diffusion regions of Mg and Zn are present where Mg and Zn are mutually diffused between the laminated aluminum alloy layers;
about indexes each representing a distribution state in the plate-thickness direction of precipitations in the aluminum alloy clad structural member,
one of these indexes being the inertial radius Rg of the precipitations which represents the size of the precipitations in each of the aluminum alloy layers and is measured by a small angle X-ray scattering technique, a central portion in the plate-thickness direction of an aluminum alloy layer in which the Mg content by percentage is the largest, out of the aluminum alloy layers, having an average inertial radius Rg ranging from 0.3 to 2.0 nm, and a central portion in the plate-thickness direction of an aluminum alloy layer in which the Zn content by percentage is the largest, out of the aluminum alloy layers, having an average inertial radius Rg ranging from 1.0 to 3.0 nm; and
another of the indexes being the scattering intensity 10 of the precipitations which represents the quantity of the precipitations in each of the aluminum alloy layers and is measured by the small angle X-ray scattering technique, the central portion in the plate-thickness direction of the aluminum alloy layer in which the Mg content by percentage is the largest, out of the aluminum alloy layers, having an average scattering intensity I0[Mg] ranging from 1000 to 5000, and the ratio of the average scattering intensity I0[Zn] of the central portion in the plate-thickness direction of the aluminum alloy layer in which the Zn content by percentage is the largest, out of the aluminum alloy layers, to the average scattering intensity I0[Mg] (the I0[Zn]/I0[Mg] ratio) ranging from 2.0 to 50.0.
